(19) United States
(12) Patent Application Publication
(10) Pub. No.: US 2009/0282965 A1
(43) Pub. Date: Nov. 19, 2009

(54) Musical sound device

(75) Inventors: Keith Matejka, Madison, WI (US); Douglas Rappaport, Los Angeles, CA (US); Brian Christian, West Covina, CA (US)

Correspondence Address: MASUVALLEY & PARTNERS, 8765 AERO DRIVE, SUITE 312, SAN DIEGO, CA, 92123, US

(73) Assignee: Konami Digital Entertainment, Inc., El Segundo, CA (US)

(21) Appl. No.: 12/152,371

(22) Filed: May 13, 2008

(51) Int. Cl. G10H 1/40

(52) U.S. Cl. 84/611

(57) ABSTRACT

The present invention is a musical sound device having an input device including a plurality of selection sections and a timing input section, a storage unit for storing first musical sound data for outputting a first musical sound, second musical sound data for outputting a second musical sound, and a rhythm pattern to output the second musical sound data, an allocation unit for allocating the first and second musical sound data to the plurality of selection sections according to a predetermined relationship, a control unit for outputting the second musical data corresponding to the input from selection section, to an output unit according to the rhythm pattern, and outputting the first musical sound data according to input from the selection section and the timing input section, to the output unit, and an output unit corresponding to the first and second musical sound data received from the control unit.

### TECHNICAL FIELD

The present invention relates to a musical sound device and a method for creating musical sound by a user using an input device. Further, the present invention relates to a musical sound device and a method for outputting first musical sound data corresponding to an input from the input device and also outputting second musical sound.

### BACKGROUND OF THE INVENTION

Conventionally, games have been known, in which a game image is provided on a display and a user performs an input using an input device having, for example a guitar-shape or a drum-shape, according to an instruction of the game image. In these games, a following method has generally been taken; there are objects moving on the display, a user performs an input when the objects reaches a predetermined position, and an adequacy of the input is judged by a gaming device. The users were enjoying the games by comparing the score obtained in these games with others or challenging for a high score by themselves (refer to U.S. Pat. No. 6,225,547). However, these game methods have been taken for a long time and a new playing method using an input device which is closer to an actual performance has been desired.

### SUMMARY OF THE INVENTION

One aspect of the present invention is a musical sound device includes;

an input device including a plurality of selection sections and a timing input section;

a storage unit for storing first musical sound data for outputting a first musical sound, second musical sound data for outputting a second musical sound and a rhythm pattern used when outputting the second musical sound data;

an allocation unit for allocating the first musical sound data and the second musical sound data to the plurality of selection sections according to predetermined relationship;

a control unit for outputting the second musical data allocated to a selection section of the plurality of selection sections, corresponding to input from any one of the plurality of selections to an output unit according to the rhythm pattern, and outputting the first musical sound data allocated to the selection section according to an input from any one of the plurality of selection sections and input from the timing input section to the output unit and

an output unit for outputting the first musical sound corresponding to the first musical sound data and the second musical sound corresponding to the second musical sound data received from the control unit.

By configuring as above, firstly, a predetermined music is provided, an instrument sound (such as a guitar sound) corresponding to an input from an instrument device of a user (such as s guitar) is outputted as melody according to the input and an instrument sound for keeping a rhythm (such as bass sound) is further outputted. For example, when the user does not perform the input, music without an output of the melody by the guitar sound or rhythm from the bass sound is played. On the other hand, when the user performs the input, the melody from the guitar sound and the rhythm from the bass sound are outputted, more complete and consonant music is played compare to the music without the input from the user. The user can feel the sensation of actually playing the music by feeling these differences. Further, because the sound outputted corresponding to the input from the user is not only the melody from the guitar sound or the like, but also the rhythm and so on is outputted, the user can feel the sensation of actually performing the music more effectively.

The first musical sound data may be data corresponding to a tone of a guitar and the second musical sound data may be data corresponding to a tone of a bass. Further, the input device is a device in a guitar-shape including a neck and a body and the plurality of selection sections may be located on the neck side and the timing input section may be located on the body side.

By configuring as above, a user performs an input using a device in a guitar-shape and a sound of the guitar is played along with a predetermined music based on the input by the user. Thus the user can be provided with a sense of performing more effectively.

The first musical sound data is formed from single sound data or chord data, the allocation unit allocates the single sound data or chord data different for each of the selection section and the output unit may output the first musical sound corresponding to the allocated single sound data or chord data.

By configuring as above, the sound data is formed from the single sound data and chord data, instead of one type of sound data, the allocation of the sound data to the selection sections can be more complicated, and thus a user can be required to perform an operation with a higher technical difficulty. In such a case, a new play method, such as to compete an operating technique among users, can be created. Further, because the music performed by the user can be created from varied sounds, the user can have a feel of satisfaction.

The allocation unit is provided with a counter for counting time from the beginning of input and the single sound data or chord data different for each of the selection section may be allocated according to the time from the beginning of input. Further, a data switching section is provided to the input device, and the allocation unit may allocate single sound data or chord data that are different for each of the selection section corresponding to the input from the data switching section.

By configuring as above, for example, the allocation of sound data to the selection section may be changed during a musical performance. Therefore, for example, even when playing the same sound “C”, an input must be made by using a selection section on a different position, thus a user can be required to perform an operation with a higher technical difficulty. In such a case, a new play method, such as to compete an operating technique among users, can be created.

The data switching section is a sensor for detecting an inclination of the input device, and the allocation unit may allocate the chord data to the selection section when the input device is in sideways and allocate single sound data to the selection section when the input device is in lengthways.

By configuring as above, the user can perform solo-play while placing the guitar in lengthways, thus the guitar play can be more varied.

The plurality of selection sections of the input device is formed from a first plurality of selection sections positioned farther from the timing input section, and a second plurality of selection sections on a position closer to the timing input section. And the allocation unit may allocate chord data to the first plurality of selection sections and single sound data to the second plurality of selection sections.

The allocation unit may allocate the first and second musical data to the plurality of selection sections in a relationship that the second musical sound corresponding to the second musical sound data is a root sound of the first musical sound corresponding to the first musical sound data.

By configuring as above, in a case when chord of music progresses in the order of C→G→DE, for example, a root sound is outputted in a predetermined rhythm from the bass sound, which is keeping the rhythm, while the chord sound is outputted from the guitar, which performing the melody. Therefore, the guitar sound and bass sound are constantly in a predetermined relationship, and the guitar sound and bass sound do not discord.

The storage unit stores a plurality of rhythm patterns used when outputting the second musical sound data, the allocation unit allocates any one of the rhythm patterns out of the plurality of rhythm patterns stored in the storage unit, and the output unit may output the second musical sound with the allocated rhythm pattern.

The allocation unit is provided with a counter for counting time from the beginning of input, and any one of the rhythm patterns may be allocated with the time from the beginning of input. Further, the input device is provided with a rhythm pattern input section and the allocation unit may allocate any one of the rhythm patterns to a selection section of the plurality of selection sections according to an input from the rhythm pattern input section.

By configuring as above, rhythm patterns in a music number can be changed freely during a performance, thus a varied music number can be created.

The musical sound device may further include a storage device for storing input history data inputted from the input device a reproducing unit for reproducing the input history data. Further, the musical sound device may include a communication unit for communicating with the server through a communication line to transmit the input history data to the server. In addition, the communication unit receives the input history data, which is stored in the server from the server and the reproducing unit may reproduce the received input history data. Also, in a case when there is an input from the input device while the reproducing unit is reproducing the received input history data, the storage device may additionally store the input history data.

By configuring as above, the user can reproduce the sound data created by the musical sound device or provide the sound data to another player. Further, the other user can make an arrangement based on the received music data and newly create original music data suitable to him/herself. Therefore, various methods for utilization of the musical sound device, such as, not only performing a music by him/herself, but also to reproducing music for others or create music by cooperating with others, can be provided.

The musical sound device may further includes a display for providing an image to execute a game, an image storage unit for storing image objects corresponding to the plurality of selection sections, an image control unit for displaying the image object so as to move on the display according to a predetermined rhythm and instructing a timing to select the image object and an evaluation unit for detecting a degree of time gap between the timing inputted from the input device and the timing to select the image object and evaluating the input timing based on the degree of the gap.

By configuring as described above, the musical sound device may be applied to a game. In this way, for example, a user can enjoy playing a game with others based on a music number created with the others.

### BRIEF DESCRIPTION OF THE DRAWINGS

FIG. 1 illustrates an example of a configuration of a musical sound device pertaining to the present invention.

FIG. 2 is a configuration diagram illustrating an example of an input device having a guitar-shape pertaining to the present invention.

FIG. 3 illustrates an example of sound data allocated to a plurality of selection sections and sets of the sound data.

FIG. 4 is a flow chart showing an example of an operation state of a musical sound device pertaining to the present invention.

FIG. 5 illustrates an example of a configuration of a musical sound device pertaining to the present invention.

FIG. 6 illustrates an example of a recording display.

FIG. 7 illustrates an example of a recording display.

FIG. 8 illustrates an example of an image displayed when a musical sound device of the present invention is applied to a game.

FIG. 9 illustrates a condition of progress of the game shown in FIG. 8.

FIG. 10 illustrates a predetermined horizontal type parameter which changes according to progress of a game.

FIG. 11 illustrates an example of a display for providing a game to a plurality of players.

FIG. 12 illustrates an example of a game display provided by a musical sound device pertaining to the present invention.

FIG. 13 illustrates an example of a game display provided by a musical sound device pertaining to the present invention.

FIG. 14 illustrates an example of rhythm pattern for outputting musical sound data.

### DETAILED DESCRIPTION OF INVENTION

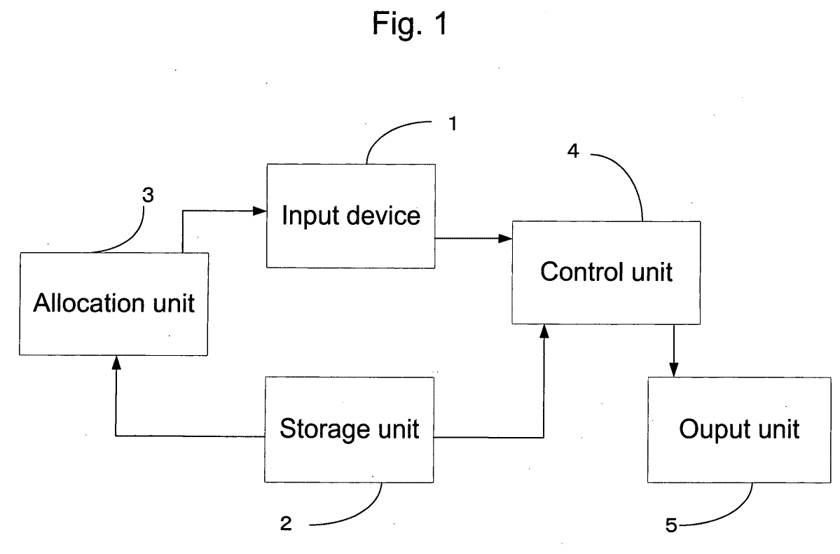

The present invention will be explained in detail below. FIG. 1 illustrates a configuration of a musical sound device pertaining to the present invention. The musical device of the present invention is provided with an input device 1, a storage unit 2, an allocation unit 3, a control unit 4 and an output unit 5.

As a concrete example of a musical sound device executed in the preset invention, firstly, a predetermined music is played. A user plays music using the input device 1 along with the music. The user will be able to know a musical score of his/her part (sound or rhythm play by him/herself) before the musical performance or at the same time of the performance. As a method to notify the user of the part to be performed may include placing a musical score on an instruction manual and preparing a display and showing a musical score on the display. The user can perform a predetermined sound using the input device 1. The input device 1 has a plurality of selection sections and a timing input section. And the user can control the sound by the selection sections. For example, selection sections A, B and C are provided to the input device, and when the user presses the selection section “A”, sound of “do” may be emitted. And when the user presses the selection section “B”, sound of “mi” may be emitted. Further, the sound emitted by each of the selection sections may change in each case. For example, a certain operation may trigger the selection section to emit sound of “la” even when sound of “do” is emitted by pressing the selection section A.

Further, the present invention is characterized that when a user emits a sound desired to perform by using the input device 1, an instrument sound, such as bass sound, is emitted corresponding to the emitted sound. The base sound or the like may be emitted to keep the rhythm of the music performed. That is, in such a case, if the user does not perform any operation, not only the sound, such as “do” or “mi” is not emitted, but also the base sound to create the rhythm for the entire music is not emitted. Conversely, the user performs an operation by the input device 1, a rhythm is performed in addition to the single sound, such as “do” or “mi”, and chord, that forms main axis of the music, thereby totally different music is performed compared to the case where the user does not perform any operation. Thus, the user can execute an adequate operation and the user can feel a satisfaction and a sense of superiority by listening more complete music.

Concretely explaining the configuration of the musical sound device pertaining to the present invention, firstly, the input device 1 has a plurality of selection sections and a timing input section. By the plurality of selection sections, a type of sound emitted from an output unit 5 is determined. Any number of the plurality of selection sections may exist and the selection sections may emit any sound, such as single sound or chord sound. Further, each of the selection sections may not necessarily be allocated with each sound. And, for example, selection section A to E exist and may be configured to output a single sound “fa” and a chord “Cm7” by pressing the selection section A and B. On the other hand, the timing input section is configured to be used to confirm the input of the selection section and may be configured to emit sound selected by the selection section.

Next, the storage unit 2 stores first musical sound data for outputting the first musical sound, second musical sound data for outputting the second musical sound and rhythm pattern in outputting the second musical sound data. The first musical sound may be, for example, sound of instrument playing melody of musical performance, such as a guitar sound. Accordingly, the first musical sound data may be formed from either single sound data or chord data, or both. The second musical sound may be, for example, instrument sound to keep rhythm, such as a bass sound. Accordingly, the second musical sound data may be for example, bass sound data. The rhythm pattern may be, for example, a rhythm pattern for emitting the bass sound, and the bass sound may be emitted according to the stored rhythm pattern. The rhythm pattern may be any rhythm. For example, the rhythm pattern may be a quarter note or eighth note. Further, the rhythm pattern for outputting the first musical sound and the rhythm pattern for outputting the second musical data may be different. Concretely, the guitar sound may be emitted with the quarter note and the bass sound may be emitted with the eighth note in one-bar.

For example, the output of the first musical sound data may be confirmed by the timing input section after selecting by the selection section. Meanwhile, the output of the second musical sound data may be confirmed by the selection section only. Next, the allocation unit 3 has a function for allocating the first musical sound data and second musical sound data to the plurality of selection sections in a predetermined relationship. That is, for example, when the plurality of selection sections is A to E, sound of “do” is outputted by pressing A, sound of “mi” is outputted by pressing B, sound of “so” is outputted by pressing C, a chord sound of “do+mi” is outputted by pressing A and B, and soon. Here, when the plurality of selection sections is selected at the same time, for example, A, which outputs the sound of “do”, and B, which outputs the sound of “mi”, are selected at the same time, the sound outputted may not be the chord sound “do+mi”. In this case, for example, it may be configured to output a sound has no relation to “do” or “mi, such as “la+si” or “fa#+so”. Further, the allocation of the sound to the selection section may be changed as needed. For example, the allocation may be configured to change by a predetermined time from the beginning of the musical performance. In such a case, the allocation unit 3 may be provided with a counter for counting time from the beginning of input, and allocate a single sound data or chord data different for each of the selection sections with time from the beginning of input. Further, for example, in a musical tune with a plurality of bars, the allocation may be configured to change when the musical tune is progressed to a predetermined part.

These switches of the allocation may be performed automatically by the musical sound device or manually by a user. In a case when the user switches the allocation of sound, for example, a data switching section is provided to the input device and the allocation unit may allocate single sound data or chord data different for each of the selection section corresponding to the input from the data switching section. The section for switching the allocation may be located anywhere. For example, a select button may be provided to the input device and the allocation may change each time the select button is pressed. For example, when selection sections A to E exist, “E, G, D, A, C” are allocated in the order of A to E before pressing the select button. And “Am, Em, F, C, D” may be allocated in the order of A to E when the select button is pressed. The sounds to be allocated each time the select button or the like may not be specifically limited, and any sounds may be allocated.

Next, the control unit 4 has a function to output the second musical sound data allocated to the selection section corresponding to the input from any of the plurality of selection sections to the output unit according to the rhythm pattern. Also, the control unit 4 functions to output the first musical sound data allocated to the selection section to the output unit according to the input of the any of the plurality of selection sections and the timing input section.

At this time, the first musical sound data and second musical sound data may be outputted to the output unit such that the second musical sound corresponding to the second musical data becomes a root sound of the first musical sound corresponding to the first musical sound data. The root sound is a single sound serves as a basis among the single sound forming a predetermined chord. That is, when the first musical sound is a chord of guitar “do mi so”, the second musical sound, such as a bass sound, may be for example, “do”. Further, since the output unit 4 can be configured to output the second musical sound in any rhythm pattern stored in the storage unit, for example, the second musical sound may be configured to output eighth note when the first musical sound is outputted in fourth note. Therefore, the second musical sound, such as a bass sound, for example, is a root sound for the guitar chord of the first musical sound, and the rhythm pattern of the bass sound may further be configured to keep a certain rhythm relationship with the rhythm pattern of the guitar sound. By configuring this way, discord does not erupt between the second musical sound, such as a bass sound, and the first musical sound, such as guitar, and consonant sound can be provided constantly. Further, a tonal bass sound is automatically selected when the user selects a guitar sound with a pitch the user desires, a natural mock session can be performed in the entire performance.

The rhythm pattern is not specifically limited and may be in any rhythm. For example, the rhythm pattern may be half note, sixteenth note, thirty-second note, or the like. Further, it may not be a note formed only from phonetic value having a certain time length. For example, it may be a rhythm by a note formed from phonetic value group having different time length. In addition, this rhythm pattern may be configured to switch in the middle of musical performance. The switch of the rhythm pattern may be performed automatically by the musical sound device, or manually by a user. In a case when the rhythm pattern is switched automatically, for example, the rhythm pattern may be configured to change at a predetermined time interval from the beginning of the musical performance. In such a case, the allocation unit 3 has a counter for counting time from the beginning of input and any of the rhythm patterns from the plurality of rhythm patterns stored in the storage unit may be allocated according to time from the beginning of input. Also, for example, the rhythm pattern may be configured to be changed when the musical performance is progressed to a certain part in a musical tune formed from a plurality of bars. On the other hand, in a case when the user switches the rhythm pattern, for example, a rhythm pattern input section is provided to the input device, and the allocation unit 3 may be configured to allocate any rhythm pattern according to the input from the rhythm pattern input section. At this time, the section to perform the switching operation of rhythm pattern may be at any location. For example, the input device may be provided with a start button, and the rhythm pattern may be configured to be changed by the start button. Further, the tone of the first or second musical sounds may be switched. The tone may be any type of tone such as, normal tune (Normal), distorted tune (Distortion) chorus tune (Chorus), reverb tune (Reverb), or delayed tune (Delay).

Next, the output unit 5 has function to output the first musical sound corresponding to the first musical sound data and the second musical sound corresponding to the second musical sound data that are received from the control unit 4.

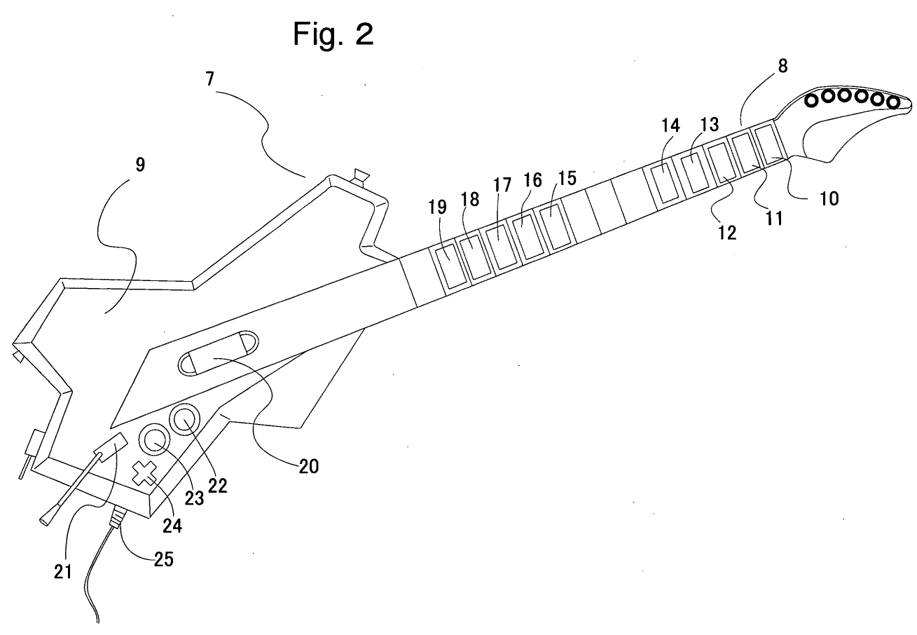

Next, the input device used in the present invention will be explained. FIG. 2 is a configuration diagram illustrating an example of an input device in a guitar shape pertaining to the present invention (herein after, also referred as a guitar for input 7).

The guitar for input 7 has a neck section 8 and a main body section 9. The neck section has a plurality of selection sections 10, 11, 12, 13, 14, 15, 16, 17, 18 and 19. Among the plurality of selection sections 10 to 19, the selection section 10 to 14 are arranged on a location far from the main body section 9, and the selection sections 15 to 19 are arranged on a location close to the main body section 9. Meanwhile, the main body section 9 is provided with a timing input section 20 and a rotary switch 21. Further, the main body section 9 is provided with a select button 22, a start button 23 and a cross-shape key 24. On the lower side of the main body section 9, a power connection 25 is attached to supply power to the guitar for input 7.

As described above, the plurality of selection sections 10 to 19 may be used to select single sound data or chord data for input. The timing input section 20 may be used to confirm the selection. The number of the plurality of selection sections may be in any number. For example, the number of the plurality of selection sections may be five or not less than 10. In addition, the plurality of selection sections may not necessarily be provided on the neck portion 8 divided in five each, and ten of the selection portions may be provided all together. Further, the plurality of selection sections may not be provided to the neck section 8, and may be provided on the main body 9 side. Meanwhile, the number of the timing input section 20 may not necessarily be one, and may be in any number. For example, one on the main body section 9 and one on the neck section, a total of two timing input section 20 may be provided. Further, the timing input section 20 may not be provided on the main body section and may be provided on the neck section. In addition, the timing input section for confirming the selection may not exist and the plurality of selection sections may select data and confirm the selection.

The rotary switch 21 is arranged on the lower side of the timing input section 20. And the rotary switch 21 may be used to switch a supplemental mode, such as an echo mode (the same types of the sounds are outputted in stagger) or a chorus mode (different types of sounds are outputted simultaneously). Further, uses of a select button 22, a start button 23, and a cross-shaped key 24 are not specifically limited and may be used in anyway. For example, they may be used to switch the sound data allocated to the selection sections to different sound data. In such a case, the sound data to be switched may be grouped in a plurality of sets. That is, for example, it may be configured as such that the sound data of set 1 are “E, G, D, A, C” and the sound data of set 2 are “Am, Em, F, C, D”. In such a case, each set may include the same sound data. Further, for example, these may be used to switch a rhythm pattern. In addition, a play mode can be selected by the select button 22 and a game with the play mode may be started by the start button 23. The cross-shaped key 24 may be used to select some sort of modes or used to select an object when a game is executed.

On to the input device, a sensor for detecting an inclination of the input device may also be provided. And the sensor may sense the inclination when the input device is placed in lengthways or sideways. Then, for example, when the sensor senses the inclination to the lengthways, the allocation unit may allocate single sound data to the plurality of selection sections. Also, when the sensor senses the inclination to the sideways, the allocation unit may allocate chord data to the plurality of selection sections. Adversary, the chord data may be allocated to the plurality of selection sections when the sensor senses the inclination to the lengthways, and the single sound data may be allocated when the sensor senses the inclination to the sideways. The lengthways and sideways referred here do not mean strictly, and “lengthways” may include a condition where the inclination is slightly lengthways. On the other hand “sideways” may include a condition where the inclination is slightly sideways.

Further, the chord data may be allocated to the selection sections 10 to 14 that are provided far from the main body section 9, and the single data may be allocated to the selection sections 15 to 19 that are provided to the positions near the main body 9. Adversary, the single sound data may be allocated to the selection sections 10 to 14, and the chord data may be allocated to the selection section 15 to 19.

Further, the guitar for input 7 may be provided with configurations other than those described above. For example, a speaker, a vibratory apparatus, or a band for positioning the guitar closer to a player's body may be provided to the guitar for input 7. Normally, the plurality of selection sections provided to the neck section 8 of the guitar for input 7 corresponds to an input unit for a left hand. Meanwhile, the timing input section 20 and the rotary switch 21 provided to the main body section 9 of the guitar for input 7 correspond to an input unit for a right hand. However, in the guitar for input 7, these input means for a right hand and left hand and may be opposite.

The input device pertaining to the present invention may not be in a guitar-shape. The input device pertaining to the present invention may be in any shape, for example, a string instrument other than the guitar, such as a violin and ukulele, a percussion instrument, such as a drum and a cymbal, a reed instrument, such as a clarinet and a flute, a keyboard instrument, such as a piano or an organ, or a turntable. Accordingly, the first musical sound may be a sound played by the instrument that is used. For example, in a case when the input device is a piano, the first musical sound may be a sound of piano. On the other hand, the second musical sound may be a sound played by anything. The second musical sound may be a sound played by, for example, a string instrument, such a bass, a percussion instrument, such as a drum or a cymbal, a triangle, or a castanet. Since the second musical sound may act as a support to the first musical sound in a rhythm aspect, it is preferably a sound from an instrument that creates a rhythm pattern.

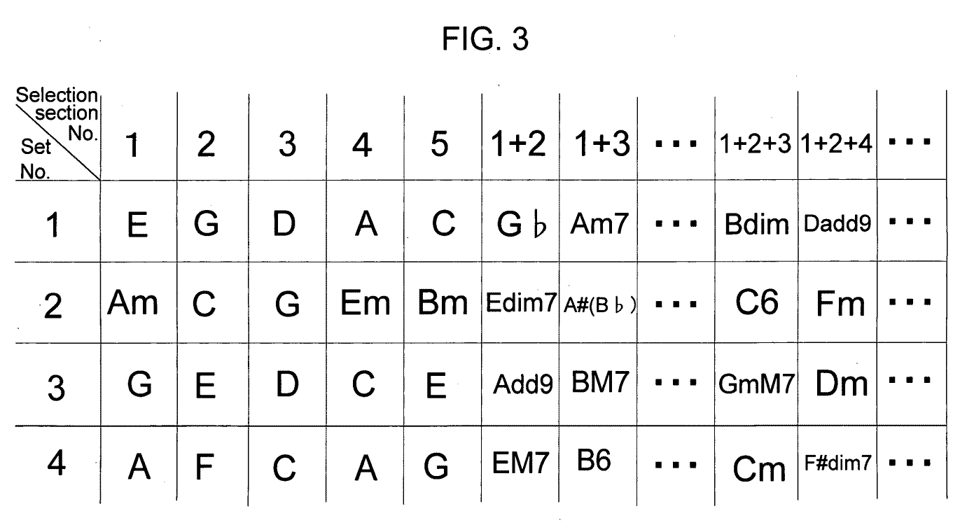

Next, the sound data to be used in the present invention and a switch of the sound will be explained. FIG. 3 illustrates an example of sound data allocated to the plurality of selection section and sets of the sound data. Numbers shown on the upper most vertical column in FIG. 3 indicate each of the buttons of the plurality of selection sections. Here, five of the plurality of selection sections exists and the numbers exist from 1 to 5 corresponding to each of the selection sections. On the lines on the far left shown in FIG. 3 indicate set numbers of the sound data allocated to the plurality of selection sections. Here, four sets of sound data are shown as a concrete example. As discussed above, these four sets of sound data can be switched and when an input is performed using the selection section while the set 1 is selected, the sound shown in the second line is outputted. That is, when an input is made by the selection section 1 while in a condition of set 1, the sound data “E” is outputted. Further, an input is made by the selection section 1+2 while in a condition of set 1, sound data “G♭” is outputted. In addition, an input is made by the selection sections 1+2+3, while the sound data “Bdim” is outputted.

Meanwhile, an input is made using the selection section while in a condition where the set 2 is selected, a sound shown in the third line is outputted. That is, for example, an input is made by the selection section 1 while in a set 2 condition, sound data “Am” is outputted. As described above, these sets of sound data can be switched as necessary, thereby a user can select appropriate sets of sound data according to the musical performance. The sound data that can be outputted by the input device is not limited to the sound shown in FIG. 3, and may output any sound data. Further, the combination of the numbers indicating the selection sections may be in any combination, such as 1+2+3+4. In addition, the set number is not limited to four, and any number of sets may exist. The content of the set of this sound data may be prepared by a user. That is, the user may be able to intentionally prepare a set such that sound data of “F” is outputted when inputting selection section 1, and the set may be stored.

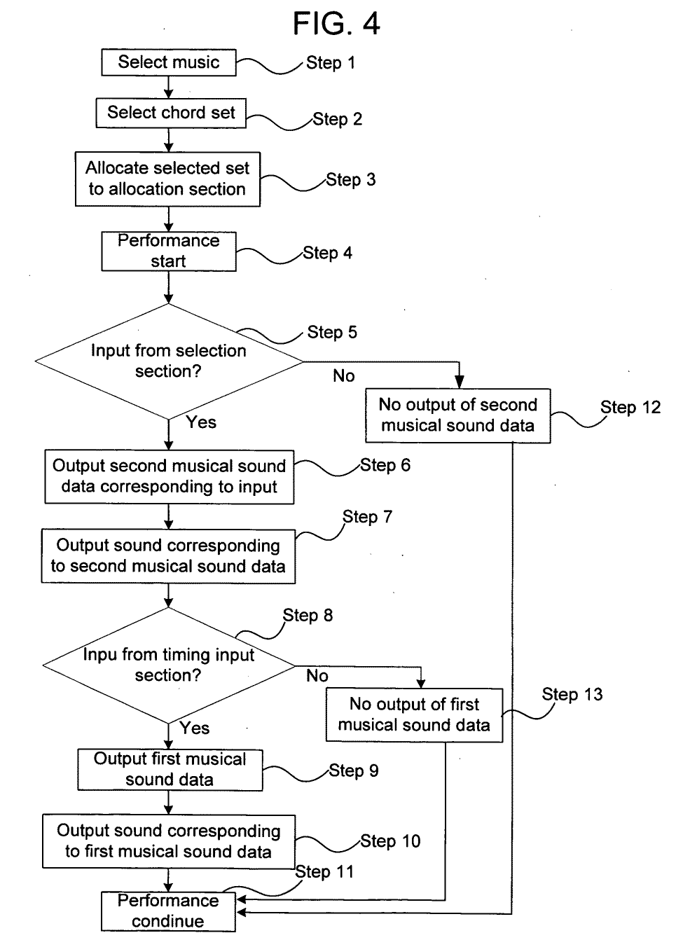

Next, an operation of a musical sound device pertaining to the present invention will be explained. FIG. 4 is a flow chart illustrating an example of an operating condition of a musical sound device pertaining to the present invention. In the musical sound device of the present invention, music is selected for performance (step 1). The selection of the music may be performed automatically by the musical sound device or by depending on an intention of a user. When the music is selected, sets of sound chord allocated to an input device are selected (step 2). The selection of the set may be performed automatically by the musical sound device or by depending on an intention of a user. When the sets of sound chord are selected, an allocation unit allocates the selected sets to the plurality of selection sections (step 3). When the sets are allocated to the plurality of selection section, musical performance is started (step 4). In addition, the selection of the sets of sound chord (step 2), and the allocation of the selected sets (step 3) may be performed after the musical performance is started.

Next, a determination is made as to whether there is an input from the selection section or not during the musical performance (step 5). When the input is determined to be performed, second musical sound data is outputted from a control unit according to the input (step 6). And the output unit, which received the second musical sound data, outputs the second musical sound (step 7). Meanwhile, when the input from the selection section is determined to be not performed, the second musical data is not outputted from the control unit (step 12), and the musical performance is continued (step 11).

When the second musical sound is outputted from the output unit, next, a determination is made as to whether there is an input from a timing input section or not (step 8). Where the input from the timing input section is determined to be performed, the first musical sound data is outputted from the control unit corresponding to the input (step 9). And, the output unit, which received the first musical sound data, outputs the first musical sound (step 10). Meanwhile, when the input from the timing input section is determined to be not performed, the first musical sound data is not outputted from the control unit (step 13), and the musical performance continues (step 11). The musical sound device of the present invention operates, for example, as described above.

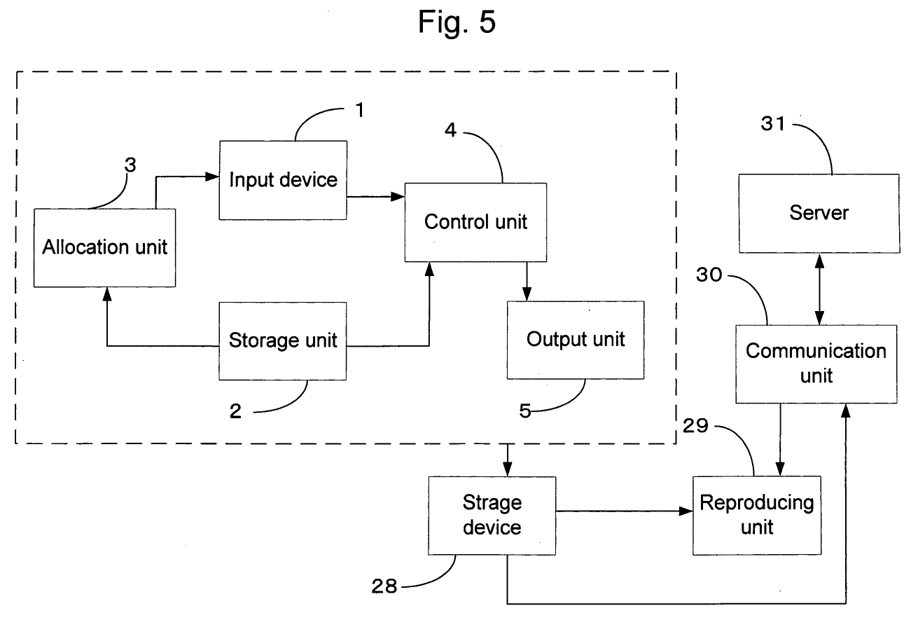

Next, a recording function and an upload function of a musical sound device of the present invention will be herein after explained. FIG. 5 illustrates an example of a configuration of a musical sound device of the present invention. The portion surround by a dotted line in FIG. 5 is as described above. As shown in FIG. 5, the musical sound device of the present invention further provided with a storage device 28, a reproducing unit 29, a communication unit 30 and a server 31. The storage device 28 functions to store data information generated between the input device 1 to the sound output unit 5. The reproducing unit 29 is to reproduce the stored data information. The communication unit 30 is to transmit the data information by communicating with the server 31 through a communication line.

The data information may be anything, for example, input history data inputted from the input device, operation history data of the input device (input timing to the selection section, input timing to the timing input section and so on), the detail of the sound allocation to the plurality of selection sections, and the first or second musical sound data outputted from the control unit. Further, the data information may be rhythm pattern or speed of the musical sound data outputted from the control unit, type or volume of the musical instrument corresponding to the outputted musical sound data, or image, if a display exists. Still further, the data information may be set data of tone data and sound data. Comparing to the case where recording wave file, which is an actual sound, since processing speed and storage capacity are decreased, storing the operating history data is more effective. When these data are stored, the actual sound can be played by the reproducing unit 29. In addition, the wave file, which is an actual sound, can also be recorded.

Further, in the musical sound device pertaining to the present invention, the communication unit 30 receives the data information stored in the server 31 and the information received from server 31 can be transmitted to the reproducing unit 29. The reproducing unit 29 can reproduce the received data information. In addition, when there is an input while the reproducing unit 29 reproducing the received data information, the storage device 28 can additionally store the new data information. Therefore, for example, a user other than the user created the data information obtains the data information through the server, and new data information created separately using the information device can be additionally stored while playing the data information by the reproducing unit. In this way, the other user can create a new musical tune by arranging the music created by others. Further, by using such a method, one music number can be created by unspecified number of users.

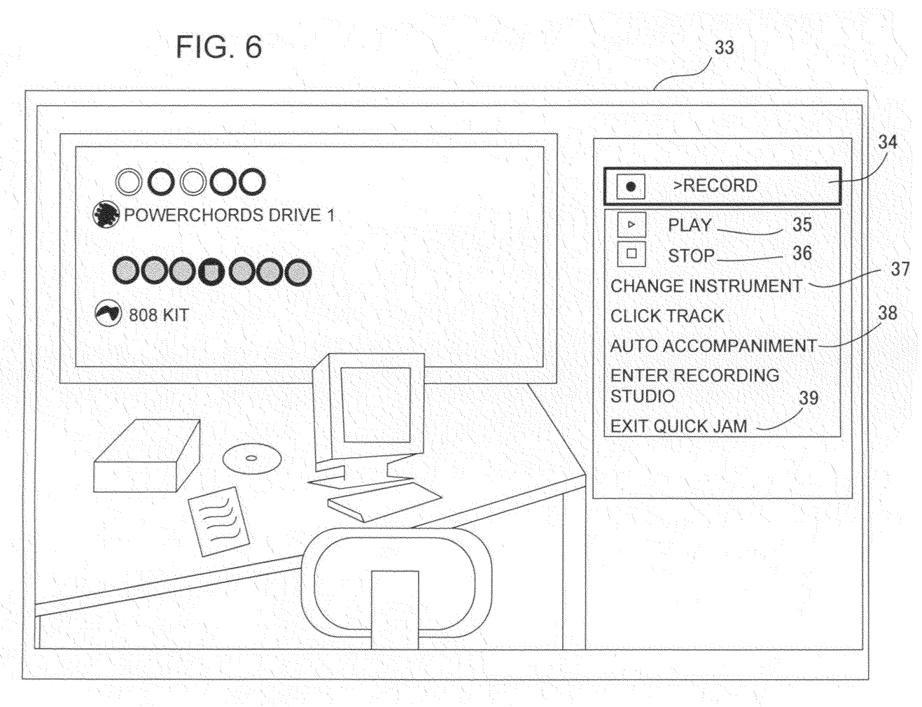

Next, a display image used in storing the data information in the storage device will be explained. FIG. 6 illustrates an example of a recording display. FIG. 6 illustrates a display 33. The display 33 shows RECORD 34, PLAY 35, STOP 36, CHANGE INSTRUMENT 37, AUTO ACCOMPANIMENT 38, and EXIT QUICK JAM 39. Music can be played or stopped by the PLAY 35 and STOP 36. Also, the CHANGE INSTRUMENT 37 enables to select an instrument to play the music. Further, the AUTO ACCOMPANIMENT 38 enables an automatic performance of the music. After selecting a predetermined instrument in this way, the musical sound, which is created by performing a melody while playing a music forming a basis, can be recorded by the RECORD 34. This mode can be ended by the EXIT QUICK JAM 39.

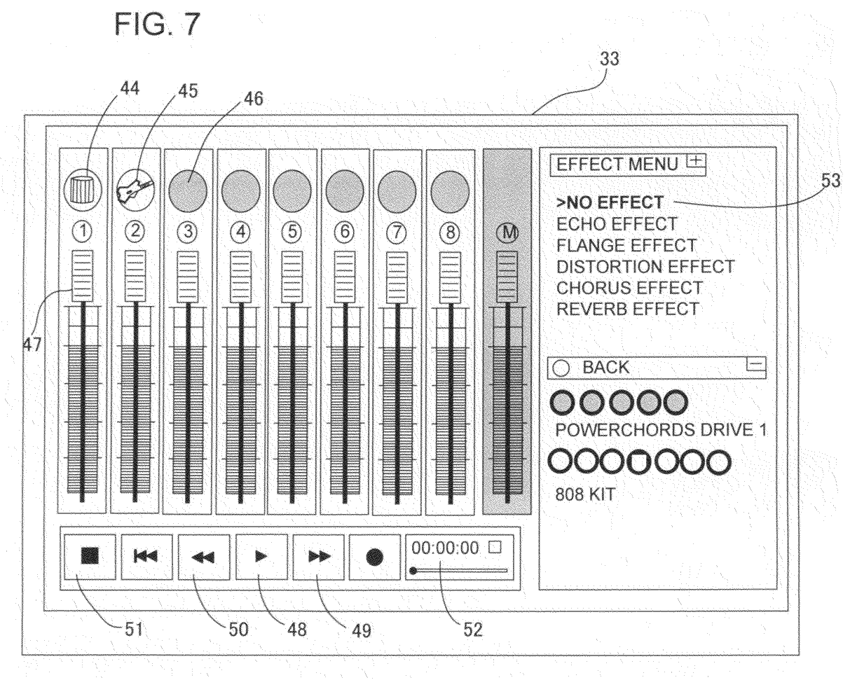

FIG. 7 illustrates an example of a recording display. In FIG. 7, a plurality of musical instruments exist, and a display capable of storing and operating musical sound of each of the instruments is shown. Musical sound by a drum 44 is stored on a line on the far left side with number 1 on the display. Buttons 48, 49, 50 and 51 can operate play, fast forward, rewind and stop of the musical sound of the drum 44. Further, a volume control 47 can operate volume of the musical sound by the drum 44. In addition, musical sound by a guitar 45 is stored on a line second from left side with number 2 on the display. Operations, such as play or volume, for the musical sound by the guitar 45 may be performed the same as the operation of the drum 44. Musical sound from each of the instruments maybe stored on the number three or later on the display. Musical performance by the plurality of instruments stored may be reproduced at the same time. In addition, a time meter 52 indicates the storing time or play time of music. Also, various types of tones can be outputted by a musical effect 53.

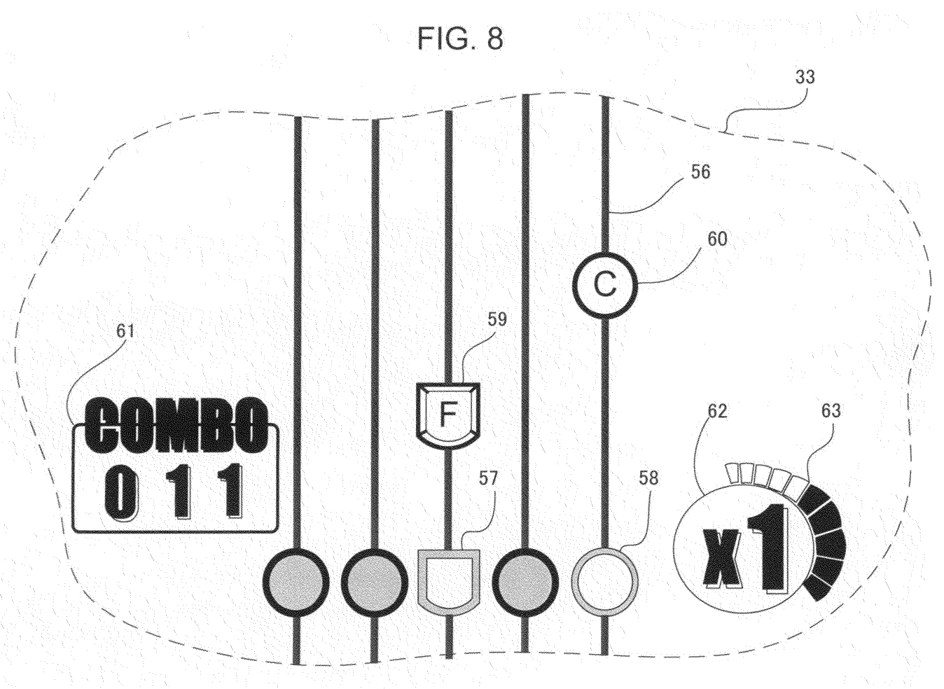

Next, a concrete example of applying a musical sound device of the present invention to a game will be explained. FIG. 8 illustrates an example of an image shown on a display in a case when the musical sound device of the present invention is applied to a game. FIG. 8 illustrates a display 33. The display 33 shows a lane 56, objects 59 and 60, marks 57 and 58 indicating the timing for selecting the objects. The object 59 indicates sound data “F” and the object 60 indicates sound data “C”. The objects are configured to move from top to bottom of the display on the lane 56. And it is arranged to add a score as a player selects an object when the object is positioned on the mark, which indicates the timing for selection. Because the sound data is allocated to the plurality of selection sections of the input device as described above, the method for selecting objects, for example, is to input a sound data “F” using the selection sections to which sound data “F” has been allocated when a player wants to input the sound data “F”.

Also, FIG. 8 shows a combo display 61, a magnification ratio 62 and a curve parameter 63. The combo may indicate, for example, the number of required operation successfully performed by a player consecutively. In a case the number of combo reaches to a predetermined value, it may be configured to add points. The curve parameter 63 may be, for example, a parameter to be increased when a player performing operation more accurately. In a case when the parameter reaches a predetermined value, it may be configured to in case the magnification ratio of the magnification ratio display 62 and the point multiplied by the ratio is added to a predetermined score.

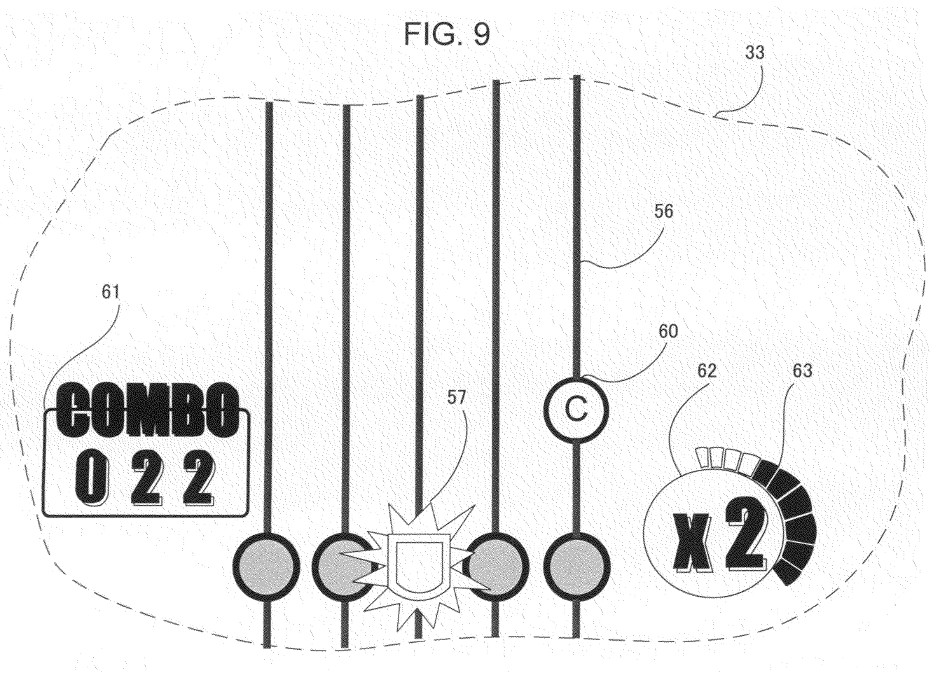

FIG. 9 illustrates a condition where the game state shown in FIG. 8 is progressed. A display 33 is shown in FIG. 9. The display 33 showing a lane 56, and a presentation object 57. FIG. 9 illustrates a condition where the objects 59 and 60 move downward on the lane, and the object 59 is selected by the input device on the mark indicating the timing for selecting the object. As a result of the selection, the object 59 is illuminated. In a case when the object is selected in favorable timing in this way, a predetermined point may be added.

Further, FIG. 9 shows a combo display 61, a magnification ratio display 62 and a curve parameter 63. By comparing to the similar display of FIG. 8, the value indicated by the combo display 61, the ratio indicated by the magnification ratio display 62, blacked out section of the curve parameter 63 are increased. In this way, a predetermined value may be increased/decreased according to the progress of game, and the predetermined value may be increased in this way as a result of correct operation from the input device.

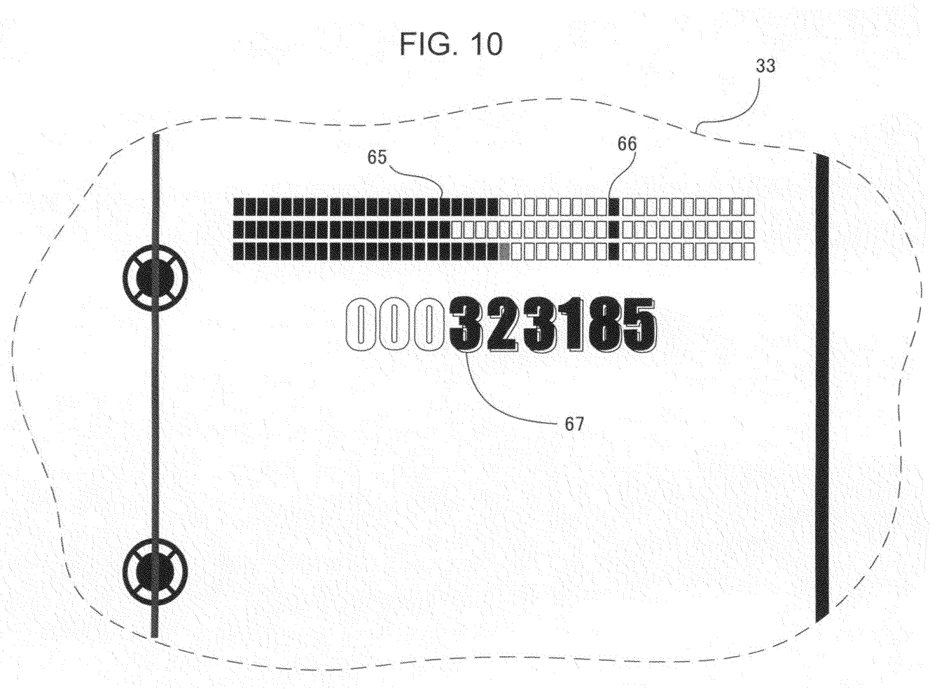

FIG. 10 illustrates a predetermined horizontal type parameter, which changes according to progress of a game. FIG. 10 illustrates a display 33. The display 33 shows a horizontal type parameter 65 and value 67. The horizontal type parameter has a vertical axis 66. According to the progress of game, the range of blacked out sections of the horizontal type parameter or the value 67 may change depending on whether the operation is good or not. For example, when favorable operations continue and the range of blacked out section of the horizontal type parameter 65 exceeds the vertical axis 66, a predetermined point may be added by performing a predetermined operation. For example, the guitar for input is normally used by holding the guitar so as to position the axis from the neck section to the main body virtually parallel to the ground. However, the predetermined point may be added as the guitar is tilted to the vertical direction against the ground when the range of the blacked out section exceeds the vertical axis 66.

The combo display 61, magnification ratio display 62, curve parameter 63, horizontal type parameter 65, and value 57 (herein after these may be referred as a parameter) that are explained in FIGS. 8 to 10 may have other functions. For example, when the parameter reaches a predetermined value, some sort of effects may be given to a counter player who is cooperating with a player or competing against the player at the same time. For example, the game operation for the counter player may become difficult or easy. Further, the number of object shown on the display of the counter player may be increased or decreased. The score, which has already obtained by the counter player may be increased or decreased. Alternatively, a third player may be able to participate.

Further, forms of the object, lane, parameter, may be in anyway. For example, the shape of the object may be in any shape, such as a star-shape, or a diamond-shape, and color of the object may be in any color such as, red, blue or a mixed color. Further, the sound data displayed on the object is not limited specifically and any sound data may be displayed. The lane may not necessarily a vertical lane, and a horizontal lane or oblique lane may exist. In stead of top to bottom, the moving direction of the object may be, reversely, from bottom to top or from left to right. Further, a game may be such that a lane does not exist, the object does not move regularly and the object is selected by the input device.

Further, for example, the method for adding point to score may be as follows. An evaluation unit is further provided to the musical sound device. Further, the storage unit 2 is storing the data for indicating the timing to select the object. By the evaluation unit, accuracy of operation inputted from the input device is judged. An input signal from the input device is transmitted to the evaluation unit. Accordingly, the data indicating the timing to select the object is also transmitted to the evaluation unit from the storage unit 2. The evaluation unit compares the received input timing and the data indicating the timing to select the object, and calculates the degree of gap in those timings. Then, the evaluation unit judges the accuracy of inputted operation based on the calculated degree of gap. It may be configured such that a higher point is normally distributed as smaller the degree of gap, and the highest score is distributed when there is no gap.

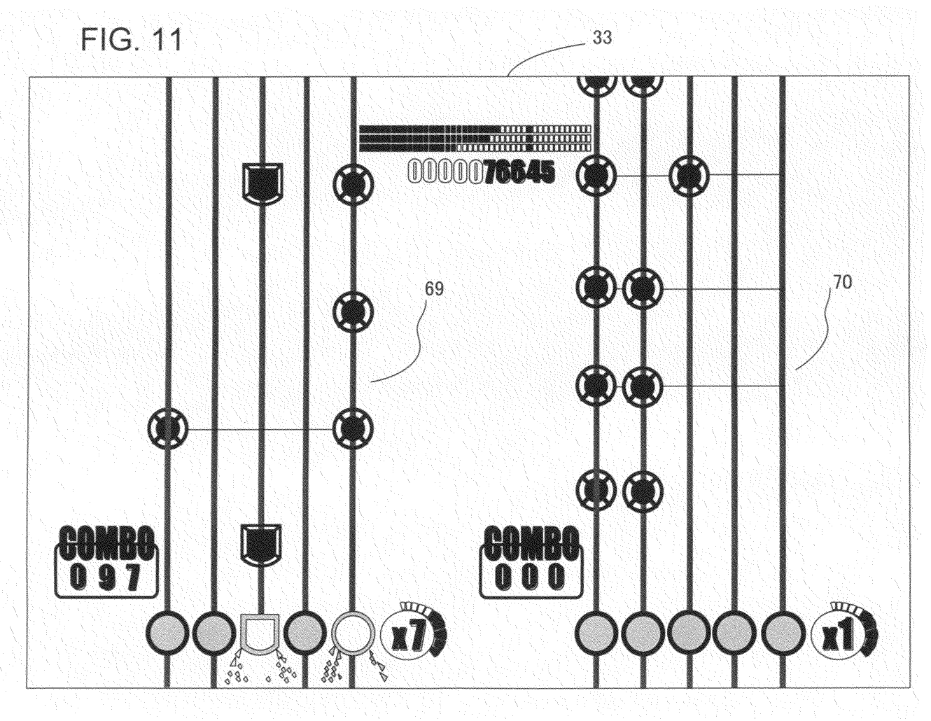

FIG. 11 illustrates an example of a display in a case when a game is provided to a plurality of players. FIG. 11 illustrates a display 33. The display 33 shows two game sets 69 and 70. In this example, two players can play at the same time, and one of the players uses the game set 69 and the other uses the game set 70. In this example, for example, two or more players can play by cooperating to each other, or competing against each other. In a case when players play the game by cooperating with each other, various parameters shown in the display 33 may be a total game score of two or more players. Meanwhile, in a case when players play the game by competing against each other, the various parameter shown on the display 33 may be decreased depending on a play result of the other player. For example, one player performs appropriate operation, score of competing player may be decreased.

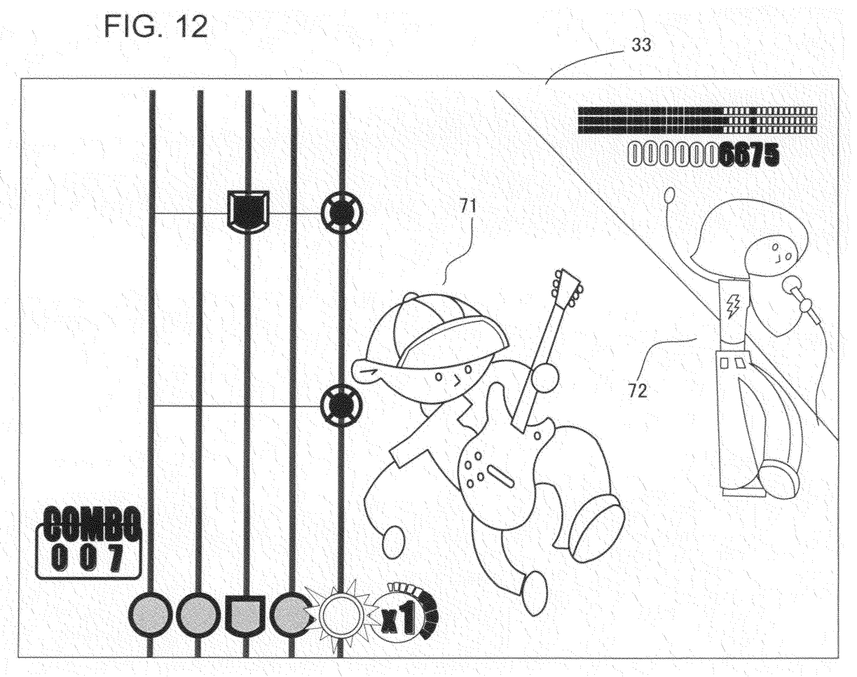

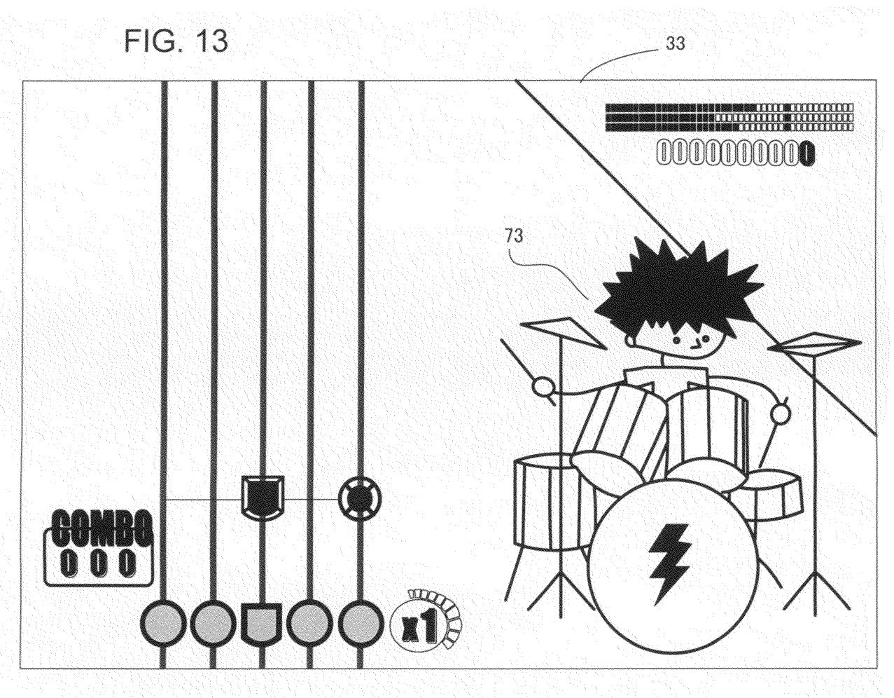

FIGS. 12 and 13 illustrate an example of a game display provided by a musical sound device pertaining to the present invention. FIGS. 12 and 13 illustrate a display 33. The display of FIG. 12 shows a character 71 playing the guitar and a character 72 holding a microphone and singing. Also, the display of FIG. 13 shows a character 73 playing the drum. In this way, the display pertaining to the present invention can further entertain players, for example, by showing characters or performing a light presentation as a presentation effect.

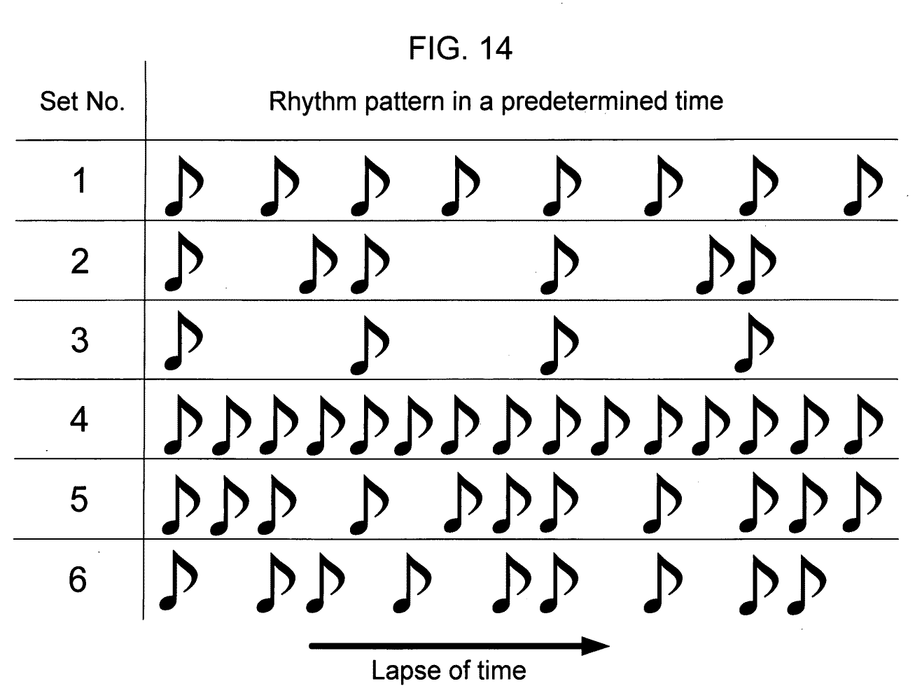

Next, a rhythm pattern used in a musical sound device pertaining to the present invention will be explained in detail. FIG. 14 illustrates an example of a rhythm pattern for outputting musical sound data. FIG. 14 illustrates six types of rhythm patters indicated by set No. 1 through No. 6. A symbol “ [symbol] ”, which normally indicates an eighth note, however, the symbol is not indicating the eighth note but indicating a meter forming a rhythm. Therefore, the rhythm pattern indicated in set number 1 is a rhythm in which eight meters are beaten in an equal interval in a given time. The rhythm patterns shown in set numbers 2 to 9 are indicated by comparing to the tempo of set number 1. For example, the time interval by meter for the rhythm pattern of the set number 3 is doubled compare to the tempo of the set number 1. That is, one meter is beaten in the rhythm of the set number 3 while two meters are beaten in the rhythm of the set number 1. The rhythm patterns indicated by other set numbers may be thought similarly. In addition, the rhythm pattern used in the musical sound device pertaining to the present invention is not limited to those shown in FIG. 14, and may be any rhythm pattern, such as an eighth note.

The present invention is concretely explained using the plurality of figures and flowcharts above, however, they are merely concrete examples and the present invention is not limited to these. For example, the storage unit and the storage device may be in any form, such as RAM (Random Access Memory), a hard disc, EEPROM (Electrically Erasable Programmable Read Only Memory), a flash memory, and ROM (Read-Only Memory). Further, the storage unit and the storage device may be a ROM cassette type (cartridge type). Also, the specification of the musical data may be anything and may be, for example, MIDI (Musical Instrument Digital Interface). In addition, as long as an operation article has an essential portion of the present invention, no matter how it is conducted, it cannot be overemphasized that it belongs to the scope of the present invention.

What is claimed is:

1. A musical sound device comprising:
an input device including a plurality of selection sections and a timing input section;
a storage unit for storing first musical sound data for outputting a first musical sound, second musical sound data for outputting a second musical sound and a rhythm pattern used when outputting the second musical sound data;
an allocation unit for allocating the first musical sound data and the second musical sound data to the plurality of selection sections according to a predetermined relationship;
a control unit for outputting the second musical sound data allocated to a selection section of the plurality of selection sections corresponding to input from any one of the plurality of selection sections to an output unit according to the rhythm pattern, and outputting the first musical sound data allocated to the selection section according to input from any one of the plurality of selection sections and input from the timing input section, to the output unit; and
an output unit for outputting the first musical sound corresponding to the first musical sound data and the second musical sound corresponding to the second musical sound data received from the control unit.

2. The musical sound device according to claim 1, wherein the first musical data is data corresponding to a tone of a guitar, and
the second musical sound data is data corresponding to a tone of a bass.

3. The musical sound device according to claim 1, wherein the input device is a guitar-shape device includes a neck and body, and the plurality of selection sections is provided on the neck and the timing input section is provided on the body.

4. The musical sound device according to claim 1, wherein the first musical sound data includes single sound data or chord data, the allocation unit allocates different single sound data or chord sound data to each of the plurality of selection sections, and
the output unit outputs first musical sound corresponding to the single sound data or the chord data allocated.

5. The musical sound device according to claim 4, wherein the allocation unit includes a counter for counting time from beginning of the input and
wherein different single sound data or chord data is allocated to each of the plurality of selection sections according to time from beginning of the input.

6. The musical sound device according to claim 4, wherein the input device includes a data switching section, and
wherein the allocation unit allocates different single sound data or chord data to each of the plurality of selection sections corresponding to an input from the data switching section.

7. The musical sound device according to claim 6, wherein the data switching section is a sensor for detecting an inclination of the input device, and
the allocation unit allocates chord data when the input device is in a sideways state and allocates single sound data when the input device is in a lengthways state.

8. The musical sound device according to claim 4, wherein the plurality of selection sections of the input device is configured by
a first plurality of selection sections located at a position further from the timing input section, and
a second plurality of selection sections located at a position closer to the timing input section, and
wherein the allocation unit allocates chord data to the first plurality of selection sections and single sound data to the second plurality of selection sections.

9. The musical sound device according to claim 1, wherein the allocation unit allocates the first and the second musical data to the plurality of selection sections in a relationship such that the second musical sound corresponding to the second musical sound data is a root sound of the first musical sound corresponding to the first musical sound data.

10. The musical sound device according to claim 1, wherein the storage unit stores a plurality of rhythm patterns used when outputting the second musical sound data,
the allocation unit allocates a rhythm pattern from the plurality of rhythm patterns stored in the storage unit, and
the output unit outputs the second musical sound with the allocated rhythm pattern.

11. The musical sound device according to claim 10, wherein the allocation unit includes a counter for counting time from beginning of the input, and
wherein the rhythm pattern is allocated to a selection section of the plurality of selection sections according to time from beginning of the input.

12. The musical sound device according to claim 10, wherein the input device includes a rhythm pattern input section, and the allocation unit allocates any one of the rhythm patterns to a selection section of the plurality of selection section according to an input of the rhythm pattern input section.

13. The musical sound device according to claim 1 further comprising:
a storage device for storing input history data inputted from the input device; and
a reproducing unit for reproducing the input history data.

14. The musical sound device according to claim 13 further comprising:
a communication unit for communicating with a server through a communication line,
wherein the input history data is transmitted to the server.

15. The musical sound device according to claim 14, wherein the communication unit receives the input history data, which has been stored in the server, from the server, and
the reproducing unit reproduces the received input history data.

16. The musical sound device according to claim 15, wherein the storage device additionally stores the input history data in a case when there is an input from the input device while the reproducing unit is reproducing the received input history data.

17. The musical sound device according to claim 1 further comprising:
a display for providing an image to execute a game;
an image storage unit for storing image objects corresponding to the plurality of selection section;
an image control unit for displaying the image objects moving on the display according to a predetermined rhythm and instructing a timing to select the image objects; and
an evaluation unit for detecting a degree of time gap between timing of an input from the input device and timing for selecting the image object and evaluating input timing based on the degree of time gap.
